(19) United States
(12) Patent Application Publication
(10) Pub. No.: US 2025/0389386 A1
(43) Pub. Date: Dec. 25, 2025

(54) PRESSURE VESSEL

(71) Applicant: Crompton Technology Group Limited, Oxfordshire (GB)

(72) Inventors: Amit Kumar Tripathi, Banbury (GB); Jonathan Pethick, Leicester (GB); James Bernard, Banbury (GB); Robert Finney, Chipping Norton (GB)

(21) Appl. No.: 19/238,863

(22) Filed: Jun. 16, 2025

(30) Foreign Application Priority Data
Jun. 19, 2024 (EP) 24275071.9

(51) Int. Cl. F17C 1/16

(52) U.S. Cl. CPC F17C 1/16; F17C 2201/0109; F17C 2203/0604; F17C 2203/0619; F17C 2203/0673; F17C 2205/0305; F17C 2209/2154; F17C 2209/234; F17C 2270/0186

(57) ABSTRACT

A pressure vessel, and a method of manufacturing a pressure vessel. The pressure vessel includes: a base layer formed from a polymer material; a reinforcement layer formed from a fibre reinforced polymer material wherein the polymer is a heat curable polymer; and an impermeable barrier layer, the barrier layer located between the base layer and the reinforcement layer; wherein the heat curable polymer has been cured at a first temperature, and wherein the barrier layer is formed from a material that is in a softened state at the first temperature.

### CROSS-REFERENCE TO RELATED APPLICATIONS

This application claims the benefit of European Patent Application No. 24275071.9 filed Jun. 19, 2024, the disclosure of which is incorporated herein by reference in its entirety.

### TECHNICAL FIELD

This disclosure relates to pressure vessels and methods for manufacturing pressure vessels.

### BACKGROUND

Various types of pressure vessels are known for storage of pressurised liquids and gases. The pressurisation of the vessels requires them to withstand considerable structural loads. The construction of pressure vessels varies depending on various usage requirements. Some pressure vessels can be made substantially entirely from metal. Other pressure vessels include varying mixtures of metals and composite materials. Some pressure vessels are made almost entirely from non-metallic materials. One set of pressure vessels, known as “Type IV” pressure vessels have the main pressure body formed entirely from non-metallic materials. Such pressure vessels are light weight and therefore useful in certain applications such as on aircraft. Type IV pressure vessels may have a composite construction typically comprising a fibre-reinforced outer layer to withstand the pressure and an inner impermeable barrier layer made from a polymer liner. However, the service life time of such constructions has normally been lower than that of corresponding metallic pressure vessels due to the higher likelihood of permeation through the layered structure.

### SUMMARY

According to a first aspect of this disclosure there is provided a pressure vessel. The vessel includes: a base layer formed from a polymer material; a reinforcement layer formed from a fibre reinforced polymer material wherein the polymer is a heat curable polymer; and an impermeable barrier layer, the barrier layer located between the base layer and the reinforcement layer. The heat curable polymer has been cured at a first temperature, and wherein the barrier layer is formed from a material that is in a softened state at the first temperature.

According to a second aspect of the present disclosure there is provided a method of manufacturing a pressure vessel. The method includes: forming a rigid base layer from a polymer material; forming an impermeable barrier layer; forming a reinforcement layer of a fibre reinforced polymer material wherein the polymer is a heat curable resin, the reinforcement layer being formed over the rigid base layer and the barrier layer such that the barrier layer is located between the rigid base layer and the reinforcement layer; and curing the reinforcement layer at a first temperature. The barrier layer is formed from a material that is in a softened state at the first temperature.

In the below it will be appreciated that various additional features may be applied to the first aspect and/or the second aspect of the disclosure. It will be appreciated that various steps of the disclosed method may be performed in any order, unless specified otherwise.

It will be appreciated that pressure vessels of the present disclosure are made from composite materials and polymer materials, which enables them to be light weight. The enclosing of the barrier layer between the base layer and reinforcement layer protects the barrier layer during the manufacturing process. In particular, it enables higher temperature curing to be used to maximise the possible strength of the fibre reinforced polymer material which is used to form the reinforcement layer. In particular, in the examples described here, the curing temperature is high enough that the barrier layer is in a softened state at that temperature. In such a softened state, the barrier layer is capable of deforming and will not hold its geometrical form on its own. Thus, such materials cannot be used at such high temperatures without a rigid base layer to support them.

In some examples the first temperature is less than the melting temperature of the barrier layer material. In such examples, although the curing temperature of the heat curable polymer is in a softened state, the barrier layer cannot change shape to the point of losing its barrier function. Thus, despite being raised to a temperature at which it is softened, the barrier layer retains its complete enclosure around the pressure vessel. This in turn prevents the creation of paths with a higher permeation rate through the vessel walls. In some examples, to retain the desired low permeation rate through the walls of the pressure vessel whilst in the softened state, the barrier layer is retained so as to keep a uniform thickness around the whole of the pressure vessel. Thus, it will be appreciated that in the softened state, the barrier material becomes more deformable. However, such deformation is restricted by the presence of the base layer and the reinforcement layer on either side. Thus, the barrier layer in the softened state can still maintain its geometrical form (and thus its barrier properties) because it is adequately supported by the base layer and the reinforcement layer.

It will be appreciated that whilst it is possible to cure some heat curable polymers at lower temperatures (e.g. temperatures at which the barrier layer is not softened), it is often desirable to use higher cure temperatures to optimise the properties of the reinforcement layer. For example, higher cure temperatures can result in increased (and potentially optimised) cross-linking such that a stronger structure is produced. Therefore the first temperature may be a temperature where an optimised cross-linked structure is produced in the fibre reinforced polymer material. Another reason to use high cure temperatures is to increase the glass transition temperature of the resulting composite material relative to cures at lower temperatures. By increasing the glass transition temperature, the resulting pressure vessel remains effective at higher operating temperatures. Thus, in some examples, the first temperature is such that the heat curable polymer achieves certain structural or chemical properties. Those properties may be required for certain regulations and/or for certain intended operating conditions. For example, one such property is that a certain degree of polymer cross-linking is achieved during cure at the first temperature. Higher temperature cures may result in larger degrees of cross-linking which in turn results in a more rigid and thus more robust structure. For example, curing at the first temperature may result in at least 90% cross-linking or may result in at least 95% cross-linking. Another such property is that a certain glass transition temperature is achieved. Curing at higher temperatures generally results in the cured fibre reinforced polymer material having a higher glass transition temperature which in turn allows the pressure vessel to be used in higher temperature environments. In some examples curing at the first temperature may result in a glass transition temperature of between 100° C. and 260° C., or between 130° C. and 240° C., or between 160° C. and 220° C. The increased cure temperature can also result in increased chemical and moisture resistance.

For lighter weight, in some examples the barrier layer is formed from a polymer material. It will be appreciated that polymer materials may have a range of temperatures above which the polymer becomes softened. In some examples, the polymer being in a softened state means that the material is above its Deflection Temperature Under Load (DTUL), i.e. the barrier layer has a DTUL below the first temperature. In other examples, the polymer being in a softened state means that the material is above its Vicat softening temperature, i.e. the barrier layer has a Vicat softening temperature below the first temperature. Therefore, by restraining the barrier layer between the reinforcement layer and the base layer during manufacture, the barrier layer, when heated above its Vicat softening temperature, cannot deform and thus retains its shape. It will be appreciated that the Vicat softening temperature and the Deflection Temperature Under Load (DTUL) are defined by standardised tests, and are measurable quantities for polymer or plastic materials. Once curing is complete and the pressure vessel is allowed to cool, the polymer material returns to its previous state, becoming rigid. In some examples the Vicat softening temperature of the barrier layer may be no more than 20° C. lower than the first temperature or it may be no more than 10° C. lower than the first temperature, or it may be no more than 5° C. lower than the first temperature. In this way, although the cure temperature is above the Vicat softening temperature, it is sufficiently close to it that there is a reduced possibility that the material deforms so as to no longer provide a uniform barrier layer when subsequently cooled. In some examples the barrier layer may be liquid impermeable. In some examples the barrier may be gas impermeable. It will be appreciated that the pressure vessel may be specifically configured for the storage of different types of liquids or gases, however in some specific examples the pressure vessel may be configured for the storage of compressed nitrogen (e.g. for use with fire extinguishers or an aircraft emergency evacuation system) or compressed carbon dioxide (e.g. for use as fire extinguishers), or compressed hydrogen (e.g. for use in hydrogen fueled vehicles) or compressed oxygen (e.g. for emergency oxygen supply in aircraft). It will be appreciated that for the barrier level to be impermeable means that the barrier layer is formed from a material with a low permeability for the contents of the pressure vessel such that the amount of content lost from the vessel due to permeation is within an acceptable limit over the lifetime of the product. For example, to be able to prevent permeation of an enclosed gas, the barrier layer should have a low gas permeability for that gas. It will be appreciated that the permeation characteristics of any given vessel may depend on the surface area of the material through which the liquid/gas can permeate. Thus, different geometries of pressure vessels designed with the same thickness of material and designed for the same contents may be able to store the contents for different lengths of time. In some examples, the barrier layer may have a gas transmission rate (e.g. an oxygen transmission rate) of less than 0.5 cm3·mm/(m2·day·atm), in some examples less than 0.1 cm3·mm/(m2·day·atm), in some examples less than 0.01 cm3·mm/(m2·day·atm). In some examples the barrier layer is formed from one of polyvinyl alcohol (PVOH), polyvinylidene chloride (PVDC) or ethylene-vinyl alcohol (EVOH). It will be appreciated that good barrier layer materials may have high associated costs, e.g. due to their processing complexities. It is therefore advantageous to use a material which can make a thin barrier layer whilst still being thick enough to prevent permeation through the barrier layer. In some examples the barrier layer may be less than 1 mm thick. The barrier layer may have a gas permeability of less than 0.1 cm3·mm/(m2·day·atm) at 20° C. and 65% humidity, or less than 0.05 cm3·mm/(m2·day·atm), or less than 0.01 cm3·mm/(m2·day·atm). EVOH may be particularly advantageous due to its very low oxygen permeability even in high relative humidity, for example less than 0.01 cm3·mm/(m2·day·atm) at room temperatures up to 65% relative humidity, and less than 0.1 cm3·mm/(m2·day·atm) at room temperatures up to 90% relative humidity. The low oxygen permeability characteristics of EVOH would allow a barrier layer of thickness 0.1-0.7 mm in a 1 litre pressure vessel to retain 90% of the oxygen at the end of a 25-year life cycle when originally filled to a pressure of 20 MPa (˜3000 psi) and kept at 20° C.

The base layer may be configured to withstand pressure vessel operational temperatures of between −55° C. and +80° C. It will be appreciated that to be able to withstand low temperatures, the base layer should have a ductile to brittle transition temperature (DBTT) of below the lowest operational temperature. For example, the base layer may have a DBTT of less than −55° C. This ensures that the base material keeps its strength under load (i.e. from the compressed contents of the pressure vessel) at the lowest operational temperatures. In some examples the base layer is formed from a polyester (e.g. polycarbonate) or polyamide (e.g. nylon) material. In some examples the base layer is formed from PA-6 (or nylon-6). It will be appreciated that polyamides, provide good structural rigidity across possible operational temperatures of the pressure vessel, as well as having high Vicat softening temperatures and melting temperatures (above the first temperature) which enable them to retain their shape to provide structure for the barrier layer during cures at the first temperature. It will be appreciated that the base layer provides a rigid base which can support the application of the reinforcement layer (i.e. the base layer can act as a support that is rigid enough to support application of fibre in a fibre deposition process (e.g. filament winding, braiding, automated fibre placement, etc.). In some examples, the base layer essentially functions as a mandrel for the application of the reinforcement layer. The base layer may also provide support for the barrier layer to be formed, e.g. the barrier layer may be formed over the base layer.

In some examples the reinforcement layer is formed from a fibre reinforced polymer material (FRP). By way of example, the fibres may be carbon fibres, glass fibres, boron fibres, etc. In some examples the forming of the reinforcement layer comprises application of continuous fibres over the base layer and the barrier layer. In some examples the forming of the reinforcement layer comprises winding fibres over the base layer and the barrier layer. In some examples the forming of the reinforcement layer comprises braiding fibres over the base layer and the barrier layer. Braiding is particularly beneficial for high volume production as the deposition rate for the reinforcement layer can be higher. In some examples the fibres are pre-impregnated with the heat curable resin e.g. before being wound or braided to create the reinforcement layer. In some examples heat curable resin may be added to the fibres after the fibres have been wound/braided (e.g. using a resin transfer moulding process), in some examples this application may be in addition to the fibres being pre-impregnated. In some examples the resin may comprise an epoxy resin. In some examples the resin may comprise an isocyanate base. The particular choices for fibre placement and resin application may be selected according to the shape of the vessel and its desired properties.

In some examples the curing comprises a two-step process. The first step of curing may include curing the reinforcement layer at a second temperature lower than the first temperature of the barrier layer. The second temperature may be a temperature at which the barrier layer is not in a softened state, e.g. it remains sufficiently rigid that it can retain its geometrical structure. The second step may include curing the reinforcement layer at the first temperature. By performing an initial cure at a lower temperature, the reinforcement layer can be solidified to a certain degree. This may help to ensure that the barrier layer is well retained by the reinforcement layer and the base layer before any softening of the barrier layer occurs (i.e. before it is heated up to a temperature at which it softens, e.g. above its Vicat softening temperature). This prevents any possible flow path for the barrier layer being present in the second stage of the cure, ensuring that the barrier layer retains its shape while it is in a softened state. The second stage of curing at the first temperature may allow the glass transition temperature of the reinforcement layer to be raised relative to the glass transition temperature of the reinforcement layer produced after the first stage of curing.

In some examples the first temperature may be in a range of 160-200° C., or in the range 180-190° C. or in other examples any combination of those ranges. In some examples the second temperature may be in the range 80-120° C., or in the range 100-120° C. An example heat curable resin for the reinforcement layer may have cure conditions of a second temperature (e.g. an in-mould temperature) of 100° C. or 120° C., and a first temperature (e.g. as a free-stand post-cure temperature) of 180° C. Using the example of EVOH as the barrier layer which has a Vicat softening temperature of 170-175° C. and melting temperature of around 185-193° C., a temperature of 100-120° C. is well below the Vicat softening temperature so the barrier layer would not deform during the first stage of curing, and at a first temperature of 180° C. during the second stage of curing, the barrier layer would become softened, but would not melt.

The pressure vessel may be configured to retain gas pressurised to 10-75 MPa (˜1,500-11,000 psi), in some examples 20 MPa (˜3,000 psi), in some examples more than 35 MPa (˜5,000 psi). It will be appreciated that different pressurisations may be suitable for different applications, and different service lengths for the pressure vessel, for example a pressurised oxygen pressure vessel for use in an aircraft may require a pressurisation of 20 MPa, or a hydrogen fuel tank vessel may require a pressurisation of 70 MPa.

It will be appreciated that the disclosed pressure vessel may be suitable for use with liquids or gases. Applications involving liquids include fuel tanks in which a liquid fuel is held under pressure. Applications involving gases include oxygen cylinders (e.g. for emergency oxygen supply on aircraft) and nitrogen cylinders (e.g. for fire suppression). Thus, the pressure vessel may be configured to store pressurised oxygen, or pressurised nitrogen. In particular, the barrier layer may be impermeable to the high pressure gas stored within the vessel (e.g. impermeable to oxygen or nitrogen). The pressure vessel may be configured for use in the interior of an aircraft. To be suitable for use in the interior of an aircraft it will be appreciated that the pressure vessel may be required to pass certain safety standards. For example, the pressure vessel may be required to be FST compliant, i.e. be safe for different applications as defined by international standards by having limited burn times/lengths, limited heat outputs when burned and not produce toxic smoke. In some examples the pressure vessel is designed to be FST compliant for the interior of an aircraft by for example using PA-6 for the base layer, EVOH for the barrier layer, and a carbon fibre reinforced polymer (CFRP) reinforcement layer with an isocyanate resin base. When situated on or in an aircraft, it may be desirable that the pressure vessel is usable for the whole life of the aircraft. If the vessel can last for the full service life of the vehicle, then servicing (which may require removing and/or replacing) can be avoided and cost can be saved. Therefore, in some examples where the pressure vessel is configured to be filled with a first gas quantity, the pressure vessel may be configured to retain at least 75% or at least 90% of the first gas quantity for at least 10 years, in some examples at least 20 years, in some examples at least 25 years. To be suitable for such service lengths, whilst remaining a light-weight pressure vessel suitable for use on an aircraft, very low gas transmission rates are advantageous, for example as provided by materials like EVOH.

In some examples the pressure vessel may further comprise at least one boss positioned at an end of the vessel, and at least one sealing member around the periphery of the boss. The barrier layer may be configured to form a seal with the or each sealing member, and the vessel may further comprise a creep ring located inside the pressure vessel around the barrier layer and the boss, the creep ring configured to hold at least the barrier layer against the sealing member. In some examples the creep ring may be configured to hold the barrier layer and the base layer against the sealing member. In some examples the pressure vessel may comprise a single boss, however in other examples the pressure vessel may comprise two bosses one at each end of the pressure vessel. In some examples, at least one boss provides a fluid communication both into the interior of the vessel (e.g. for filing or vacating the contents). In some examples both bosses can provide such fluid communication paths. However, in some examples only one boss provides a fluid communication path. In such examples, the second boss (if present) may be provided for structural support, e.g. for mounting or for parts of the manufacturing process. For example, the second boss may assist during the winding/braiding of fibres to create the reinforcement layer by being capable of being held during application of the fibres.

In some examples the method may further comprise: providing at least one boss at an end of the pressure vessel; locating at least one sealing member around the periphery of the boss; forming a seal between the barrier layer and the sealing member; and fitting a creep ring around the boss and the barrier layer on the inside of the pressure vessel. In some examples, fitting the creep ring comprises fitting the creep ring around the boss, the base layer and the barrier layer on the inside of the pressure vessel.

The creep ring may help to keep the barrier layer in contact with the sealing member during the manufacturing process by hindering the deformation and/or movement of the barrier material when it is in the softened state, e.g. above its Vicat softening temperature. The creep ring may ensure that there is no room for expansion of the barrier layer during curing at the first temperature. The arrangement of the creep ring around the barrier layer and the boss helps maintain the seal between the barrier layer and the sealing member(s), e.g. by maintaining a biasing force between them, ensuring proper sealing between the barrier layer and the sealing member and preventing leaks from occurring around the boss. This can ensure there is no permeation path possible around the boss (e.g. into the reinforcement layer), as the barrier layer is prevented from creeping away from the sealing member(s) over time. The creep ring may be further configured to hold the base layer against the boss. This may also help keep the base layer in place during manufacture, again preventing the formation of any flow path for the barrier layer. During the lifetime of the pressure vessel, the creep ring may also then prevent creep of the base layer away from the boss, also helping to ensure the barrier layer retains its seal against the sealing member(s).

In some examples the creep ring is metallic. The creep ring may be made from steel, or bronze, or brass, or any other suitable material which has material properties which remain stable throughout the manufacturing of the pressure vessel, i.e. above the first temperature. As the creep ring is a small component of the whole pressure vessel, the weight it contributes is minimal.

In some examples the boss may comprise at least one groove around the periphery of the boss. The or each sealing member may be seated in at least one groove of the boss. The boss may comprise a flange around its periphery. The flange may be sandwiched between the reinforcement layer and the barrier layer. The engagement of the flange with these layers may ensure the boss is retained in place relative to the rest of the pressure vessel. The base layer and the barrier layer may be formed around the boss (i.e. during manufacture), or the boss may be positioned relative to the base layer and the barrier layer after they have been formed. The fibre reinforced polymer layer may be formed over the boss (and the base layer and barrier layer) after the boss has been put in place.

The pressure vessel may comprise at least two sections. The method may further comprise connecting the at least two sections of the vessel together (e.g. to form the whole pressure vessel). The creep ring may be fitted before the at least two sections of the pressure vessel are connected together. The reinforcement layer may be formed over the base layer and the barrier layer after the at least two sections of the pressure vessel have been connected together. The pressure vessel may comprise two end portions and a central portion all connected together during manufacture. The pressure vessel may comprise two halves connected together during manufacture.

According to a third aspect of the present disclosure, a pressure vessel is provided. The pressure vessel includes: a base layer formed from a polymer material; a reinforcement layer formed from a fibre reinforced polymer material wherein the polymer is a heat curable resin; a barrier layer formed from an impermeable material, the barrier layer located between the base layer and the reinforcement layer; at least one boss positioned at an end of the vessel, and at least one sealing member around the periphery of the boss. The barrier layer is configured to form a seal with the or each sealing member, and wherein the vessel further comprises a creep ring located inside the vessel around the barrier layer and the boss, the creep ring configured to hold at least the barrier layer against the sealing member.

According to a fourth aspect of the present disclosure, a method for manufacturing a pressure vessel is provided. The method includes: providing at least one boss at an end of the vessel; locating at least one sealing member around the periphery of the boss; forming a rigid base layer from a first polymer material; forming a barrier layer from an impermeable material; forming a seal between the barrier layer and the sealing member around the boss; and forming a reinforcement layer of a fibre reinforced polymer material. The polymer is a heat curable resin, the reinforcement layer being formed over the base layer and the barrier layer, the barrier layer located between the base layer and the reinforcement layer; and fitting a creep ring around the boss and the barrier layer on the inside of the vessel.

It will be appreciated that the features described above in relation to the first and second aspects may equally be applied to the third and fourth aspects. In particular it will be appreciated that in these third and fourth aspects, the features associated with the first temperature (i.e. the first curing temperature) are not required, but may in some examples also be applicable in combination with the other features of the third and fourth aspects.

According to a fifth aspect of the present disclosure, a pressure vessel is provided. The pressure vessel includes: a base layer formed from a polymer material; a reinforcement layer formed from a carbon fibre reinforced polymer (CFRP) material; and an impermeable barrier layer formed from ethylene-vinyl alcohol (EVOH), wherein the barrier layer is located between the base layer and the reinforcement layer.

According to a sixth aspect of the present disclosure there is provided a method of manufacturing a pressure vessel. The method comprising: forming a rigid base layer from a polymer material; forming an impermeable barrier layer from ethylene-vinyl alcohol (EVOH); and forming a reinforcement layer from a carbon fibre reinforced polymer (CFRP) material, the reinforcement layer being formed over the rigid base layer and the barrier layer such that the barrier layer is located between the rigid base layer and the reinforcement layer.

In some examples, the base layer is formed from a polyamide (e.g. nylon) material or a polyester material (e.g. polycarbonate, polyethylene terephthalate, polybutylene terephthalate, etc.). In some examples the base layer is formed from PA-6. It will be appreciated that in these fifth and sixth aspects, the pressure vessel may be cured at a first temperature which is below the Vicat softening temperature and/or under the DTUL of the EVOH. In such cases, the structural support of the base layer is not necessarily required to maintain the geometry of the barrier layer while it is in a softened state (e.g. it may not be in a softened state), but it still provides structural support for application of a very thin barrier layer which can be advantageous especially where the barrier layer is hard to process and/or is expensive to produce.

It will be appreciated that the features described above in relation to the first and second aspects may also be applied to the fifth and sixth aspects. In particular the structural and geometrical features and those features relating to the barrier layer being EVOH and/or the reinforcement layer being formed from CFRP.

### BRIEF DESCRIPTION OF THE FIGURES

Certain preferred examples of this disclosure will now be described, by way of example only, with reference to the accompanying drawings, in which:

FIG. 1 shows a cross-section of an example pressure vessel;

FIG. 2 illustrates the layers in the walls of the pressure vessel of FIG. 1;

FIG. 3 shows a flow chart of a method of manufacturing the pressure vessel of FIG. 1; and

FIG. 4 shows a perspective view of a cross-section of the pressure vessel of FIG. 1 during manufacture.

### DETAILED DESCRIPTION

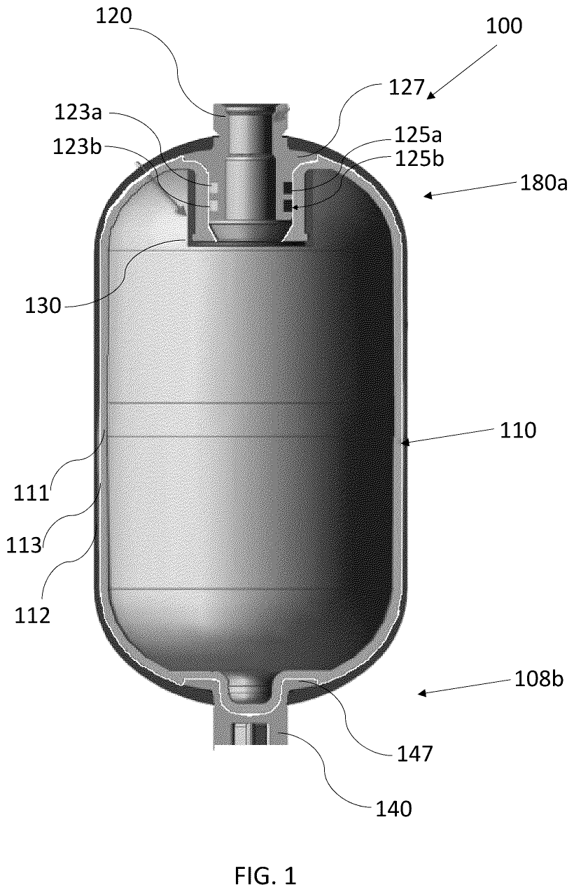

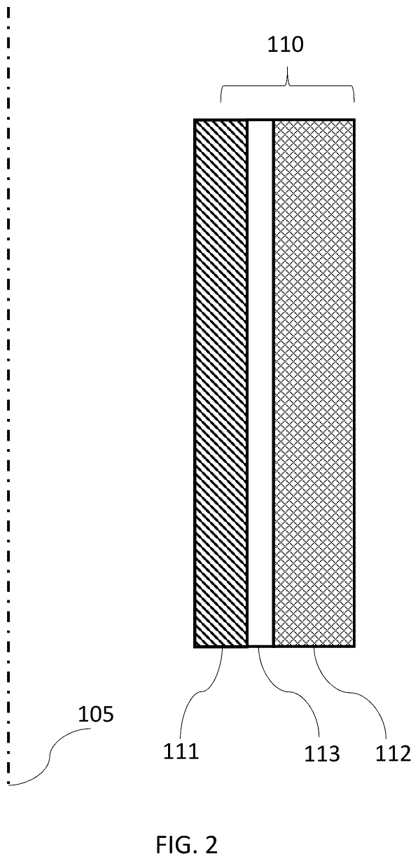

FIG. 1 shows a cross-section of an example pressure vessel 100, with walls 110 a boss 120 at a first end 108a and an end piece 140 at a second end 108b. The walls 110 are formed from three layers; an innermost base layer 111, a reinforcement layer 112, and a barrier layer 113 (located between the base layer 111 and reinforcement layer 112 in FIG. 1). These layers will be described further below with reference to FIG. 2. The boss 120, located at the first end 108a of the pressure vessel 100, has two grooves 123a, 123b formed in its outer circumference on a portion located inside the pressure vessel. Each groove 123a, 123b forms a seal seat. Each groove 123a, 123b has a sealing member 125a, 125b seated therein. The barrier layer 113 is formed on the radially outer surface of the majority of the base layer 111. However, as the base layer 111 turns inwards adjacent to the boss 120, the barrier layer 113 is formed adjacent to the boss and thus adjacent to the sealing members 125a, 125b. The barrier layer 113 thus sealed against the sealing members 125a, 125b when the boss 120 is inserted. The barrier layer 113 and base layer 111 are held against the sealing members 125a, 125b by a creep ring 130 inside the pressure vessel 100. The boss 120 is secured into the vessel with a flange 127 sandwiched between the barrier layer 113 and the reinforcement layer 112. The barrier layer 113 and the base layer 111 therefore turn inward to the vessel at the flange 127, so that the boss 120 is sealed against the barrier layer 113 at the sealing members 125a, 125b. The boss 120 provides the only point in the pressure vessel 100 where contents of the pressure vessel can be released (or through which the pressure vessel can be filled/pressurised). The end piece 140 has similar a flange 147, also sandwiched between the barrier layer 113 and the reinforcement layer 112. The end piece 140 provides additional structure to the opposite end of the pressure vessel 100, whilst the base layer 111 and barrier layer 113 have no gaps which could allow escape of the contents (i.e. the end piece 140 lies fully outside the vessel interior and does not provide fluid communication therewith). The contents of the pressure vessel 100 can only exit the vessel 100 via the fluid path in the boss 120. The barrier layer 113 prevents any significant permeation through the walls and the sealing members 125a, 125b prevent permeation between the barrier layer 113 and the boss 120. The creep ring 130 maintains this seal.

FIG. 2 illustrates the layers of the wall 110 of the pressure vessel 100 of FIG. 1, where 105 represents the central axis of the vessel. The innermost layer (closest to the axis 105) is the base layer 111. The base layer 111 is covered on its radially outer surface by the impermeable barrier layer 113. The reinforcement layer 112 is in turn formed over the radial outer surface of the barrier layer 113. The base layer 111 and reinforcement layer 112 thus sandwich the barrier layer 113 to prevent any flow or deformation of the material of the barrier layer 113 during manufacture, as described further below. In particular, the base layer 111 and reinforcement layer 112 hold the geometrical structure of the barrier layer 112, thus maintaining its impermeability properties. Whilst only three layers are shown in this example, it will be appreciated that additional layers may also be present supplementing those shown here.

In one example (which will be understood to be non-limiting), suitable for use as a pressurised oxygen cylinder on an aircraft, the base layer 111 is formed from PA-6 which has a low ductile to brittle transition temperature, and a high softening point and a high melting point (higher than the highest cure temperature that will be applied), so it retains its rigidity during the whole of the manufacturing process described below, as well as during operational conditions as low as −55° C. (e.g. in a depressurised aircraft at altitude). The barrier layer 113 is made of EVOH. This layer can be a relatively thin layer with a thickness of around 0.5-0.6 mm whilst having an oxygen permeability as low as 0.006 cm3·mm/(m2·day·atm) at 20° C. and 0% relative humidity. The reinforcement layer 112 is a braided CFRP (carbon fibre reinforced polymer) layer which provides excellent strength characteristics, to ensure the pressurized contents of the vessel are contained, even in operating temperatures above 100° C.

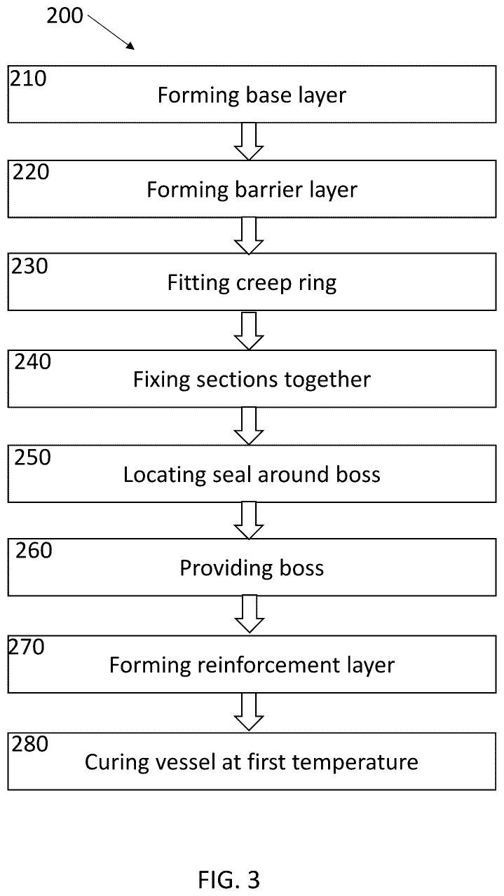

FIG. 3 is a flow diagram showing the steps of a method 200 to manufacture the pressure vessel of FIG. 1. Firstly, the base layer is formed in step 210. In some examples the base layer is formed in two halves. When a polymer base layer is used, the base layer can be injection moulded to ensure the inner dimensions of the vessel are as required. The polymer material then forms a rigid base layer onto which the rest of the vessel can be formed. Once the base layer is rigid, the barrier layer is formed in step 220. The barrier layer may be formed for example by over-moulding an impermeable material (e.g. EVOH) over each half of the base layer. In this example, the barrier layer is supported by the structure of the base layer during manufacture, so the barrier layer can be thin relative to the base layer. However, it will be appreciated that in other examples the barrier layer may be formed first, with the base layer subsequently formed inside the barrier layer.

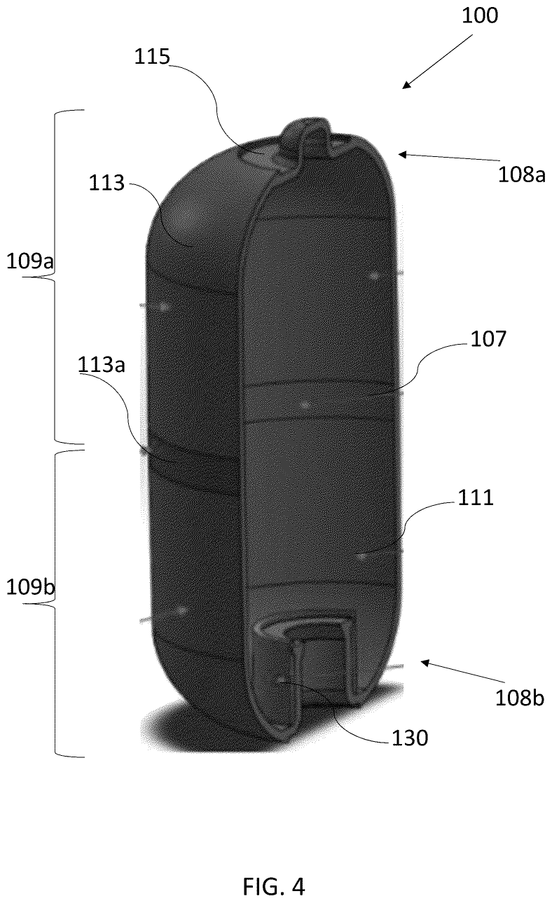

In step 230, the creep ring is fitted to the vessel. By forming the initial layers of the walls of the vessel in two halves, the inside of the vessel can be accessed. This then allows a creep ring to be fitted easily on the inside of the vessel. In this example the creep ring is fitted over both the base layer and the barrier layer inside the vessel, as seen in FIG. 4. By fitting the creep ring early during manufacture, it is ensured that the barrier layer is held in place for the remaining parts of manufacture, and during use.

It will be appreciated that in other methods the creep ring may be fitted at different points during manufacture, for example once a boss has already been provided at the end of the vessel. In some examples the creep ring may not be fully fitted over the base layer, instead being fitted directly inside the barrier layer. Whilst a creep ring may still be fitted in examples in which the vessel is manufactured as a single piece (rather than as two halves), it will be appreciated that it may be simpler and more reliable to place the creep ring inside the vessel if the vessel is manufactured in two halves.

In step 240 the two halves of the vessel are fixed together. It will be appreciated that there are various manners in which to attach sections of a vessel together, but in one example the two halves are welded together. To ensure the barrier layer fully encapsulates the vessel, an additional section of impermeable material 113a may be formed around the joint as shown in FIG. 4.

FIG. 4 shows how the pressure vessel 100 may appear at this stage of manufacture, with the inside of the vessel being the base layer 111, and the outer layer being the barrier layer 113. The vessel 100 is formed of two halves 109a, 109b, with weld line 107 shown on the inside of the vessel, and the additional section of impermeable material 113a formed around the outside of the vessel (over the weld line 107) to ensure the vessel is fully encapsulated with the barrier layer 113. The creep ring 130 is shown at a first end of the vessel 108a. An indentation 115 is shown at the second end 108b, where the end piece 140 will later be fitted onto the vessel 100. The base layer 111 and barrier layer 113 may have a similar indentation at the first end 108a (not shown) to allow the boss 120 and its sealing members 125a, 125b to be seated on the vessel in the correct position relative to the barrier layer 113.

Returning to FIG. 3, once the two sections 109a, 109b of the vessel 100 have been fixed together in step 240, the sealing members 125a, 125b are located around the boss 120 in step 250. The boss 120 may be as shown in FIG. 1 and have grooves 123a, 123b in which the sealing members 125a, 125b are seated. Alternatively, the sealing members may protrude from the periphery of the boss without grooves. At step 260, the boss 120 can then be seated into position so the sealing members 125a, 125b seal against the barrier layer 113, by mounting the boss 120 into the end of the vessel 100. The end piece 140 can be mounted onto the indentation 115 at the opposite end of the vessel 100 if required. The boss 120 is fitted so that the barrier layer 113 (and in the example of FIGS. 1 and 4 the base layer 111) is then held in place against the sealing members 125a, 125b by the creep ring 130, which is already in place on the inside of the vessel 100. By shaping the barrier layer 113 and base layer 111 before the boss 120 is mounted into the vessel 100, the layers 113, 111 can be appropriately shaped to ensure a snug fit with the boss 120 around the flange 127. In other example methods, the boss 120 may be mounted at earlier stages during manufacture, for example the base layer 111 and the barrier layer 113 may be formed directly around the boss 120 during moulding, or the boss 120 may be provided before the creep ring 130 is fitted.

At step 270, the reinforcement layer 112 is then formed over the vessel 100, sandwiching the flange 127 of the boss 120 and the flange 147 of the end piece 140 between the barrier layer 113 and the reinforcement layer 112, thereby ensuring that they stay in place. By providing an end piece 140 on the opposite end of the vessel 100 to the boss 120, the boss 120 and end piece 140 can be used to hold the vessel 100 in position while fibres are wound or braided onto the vessel 100 to make the reinforcement layer 112. The base layer 111 provides the rigid structure upon which the fibres can be placed (i.e. it acts as a mandrel for the winding/braiding process). Said fibres may be pre-impregnated with resin. However, in some examples once the fibres are wound or braided onto the vessel, the vessel is then placed into a mould and a resin is added around the fibres (e.g. a resin transfer moulding process). In such examples, the fibres may be dry wound or dry braided (i.e. not pre-impregnated). In such examples a first-stage cure is performed at a temperature (referred to elsewhere as the second temperature) which is sufficient to change the resin to a rigid state, but which is low enough that the barrier layer remains rigid (i.e. the temperature is low enough that the barrier layer does not change to a softened state). For example, and the temperature (i.e. the second temperature) of the first cure may be below the Vicat softening temperatures of the barrier layer 113. The barrier layer 113 is therefore not at risk of deformation during the first cure stage.

At step 280, once the first-stage curing has taken place (if it is required), or when using pre-impregnated fibres which do not require a first cure, the whole pressure vessel is cured at a first temperature. This first temperature high enough to produce a more optimised cross-linked structure in the reinforcement layer 112, and is also high enough to raise the glass transition temperature so that the pressure vessel 100 is safe for use in locations such as the interior of an aircraft at elevated temperatures. This first temperature is above the point at which the barrier layer 113 changes to a softened state. For example, it may be above the Vicat softening temperature of the barrier layer. By way of example, an EVOH barrier layer may have a Vicat softening temperature of ˜170° C. and a melting temperature of ˜185° C., so a cure temperature of 180° C. (which can achieve greater than 90% cross-linking and a suitably elevated glass transition temperature of ˜220° C. in an isocyanate based resin) will only cause softening, but not melting of the barrier layer 113. As the barrier layer is held in place, sandwiched between the base layer 111 and the reinforcement layer 112, it is not able to deform, so it retains its uniform thickness despite the curing at this first temperature above its softening point.

Once the pressure vessel 100 has been left to cool after the curing has been completed, it is suitable for filling with pressurised gas and deploying for use. For example, the construction shown in FIG. 2 may be suitable for containing pressurised gas (e.g. oxygen) for up to 25 years if required. The present disclosure therefore provides an effective structure for a pressure vessel and an effective method for manufacturing a pressure vessel suitable for long term use, especially for deployment in aircraft (e.g. as safety oxygen supply vessels).

It will be appreciated by those skilled in the art that the disclosure has been illustrated by describing one or more specific aspects thereof, but is not limited to these aspects; many variations and modifications are possible, within the scope of the accompanying claims.

1. A method of manufacturing a pressure vessel, the method comprising:
forming a rigid base layer from a polymer material;
forming an impermeable barrier layer;
forming a reinforcement layer of a fibre reinforced polymer material wherein the polymer is a heat curable resin, the reinforcement layer being formed over the rigid base layer and the barrier layer such that the barrier layer is located between the rigid base layer and the reinforcement layer; and
curing the reinforcement layer at a first temperature;
wherein the barrier layer is formed from a material that is in a softened state at the first temperature.

2. The method as claimed in claim 1, wherein the barrier layer has a Vicat softening temperature below the first temperature.

3. The method as claimed in claim 1, wherein the barrier layer is formed from a polymer material;
wherein the barrier layer is formed from ethylene vinyl alcohol (EVOH).

4. The method as claimed in claim 1, wherein the base layer is formed from a polymer material which is in a rigid state at the first temperature.

5. The method as claimed in claim 1, wherein the base layer is formed from a polyamide material;
wherein the polyamide material is PA-6.

6. The method as claimed in claim 1, wherein forming the reinforcement layer comprises braiding or winding fibres over the base layer and the barrier layer.

7. The method as claimed in claim 6, wherein the fibres are pre-impregnated with the heat curable resin before being braided or wound.

8. The method as claimed in claim 1, wherein the curing comprises a two-step process; wherein the first step comprises curing the reinforcement layer at a second temperature at which the barrier layer is not in a softened state; and
wherein the second step comprises curing the reinforcement layer at the first temperature.

9. The method as claimed in claim 1, wherein the first temperature is in a range of 160-200° C.; and
optionally wherein the second temperature is in the range 80-120° C.

10. The method as claimed in claim 1, further comprising:
providing at least one boss at an end of the pressure vessel;
locating at least one sealing member around the periphery of the boss;
forming a seal between the barrier layer and the sealing member; and
fitting a creep ring around the boss and the barrier layer on the inside of the pressure vessel; and
wherein fitting the creep ring comprises fitting the creep ring around the boss, the base layer and the barrier layer on the inside of the pressure vessel.

11. The method as claimed in claim 1, wherein the pressure vessel comprises at least two sections; and wherein the method further comprises:
connecting the at least two sections of the pressure vessel together;
wherein the creep ring is fitted before the at least two sections of the pressure vessel are connected together; and
wherein the reinforcement layer is formed over the base layer and the barrier layer after the at least two sections of the pressure vessel have been connected together.

12. The method as claimed in claim 1, wherein the pressure vessel is configured for use in the interior of an aircraft.

13. A pressure vessel, the pressure vessel comprising:
a base layer formed from a polymer material;
a reinforcement layer formed from a fibre reinforced polymer material wherein the polymer is a heat curable polymer; and
an impermeable barrier layer, the barrier layer located between the base layer and the reinforcement layer;
wherein the heat curable polymer has been cured at a first temperature, and wherein the barrier layer is formed from a material that is in a softened state at the first temperature.

14. A pressure vessel, the pressure vessel comprising:
a base layer formed from a polymer material;
a reinforcement layer formed from a fibre reinforced polymer material wherein the polymer is a heat curable resin;
a barrier layer formed from an impermeable material, the barrier layer located between the base layer and the reinforcement layer;
at least one boss positioned at an end of the vessel; and
at least one sealing member around the periphery of the boss;
wherein the barrier layer is configured to form a seal with the sealing member, and wherein the vessel further comprises a creep ring located inside the vessel around the barrier layer and the boss, the creep ring configured to hold at least the barrier layer against the sealing member.
